(19) United States
(12) Patent Application Publication
(10) Pub. No.: US 2016/0158994 A1
(43) Pub. Date: Jun. 9, 2016

(54) Valve Arrangement

(71) Applicant: EUGEN SEITZ AG, Wetzikon (CH)

(72) Inventors: Joachim SCHMIDT, Hettlingen (CH); Christian ELBS, Ennetbühl (CH); Roland SCHNETZER, Wetzikon (CH)

(21) Appl. No.: 14/906,390

(22) PCT Filed: Jul. 14, 2014
(86) PCT No.: PCT/CH2014/000105

§ 371 Date: Jan. 20, 2016

(30) Foreign Application Priority Data
Jul. 22, 2013 (EP) 13405083.0

(51) Int. Cl. B29C 49/60; F16K 31/122

(52) U.S. Cl. CPC B29C 49/60; F16K 31/122; B29C 2049/6045

(57) ABSTRACT

A valve arrangement is provided having a main valve having a switching piston guided in a valve housing, which switching piston can be moved relative to the valve housing between a first position, in which the main valve is closed, and a second position, in which the main valve is open. A control surface of the switching piston may transfer a control force onto the switching piston. At least one bore connecting a control air switching chamber to the control chamber in terms of flow may introduce control air into the control chamber for closing the main valve, and may vent the control chamber when opening the main valve. A control air bore may introduce control air to the control air switching chamber, in which a venting bore terminating in the control air switching chamber may be provided to vent the control chamber when the main valve is opened.

The present invention pertains to a valve arrangement according to the preamble of independent claim 1.

Accordingly, the invention particularly concerns a valve arrangement featuring a main valve with a switching piston that is guided in a valve housing and can be displaced relative to the valve housing between a first position, in which the main valve is closed, and a second position, in which the main valve is open. The switching piston features a control surface that faces a control chamber of the valve housing and is designed for transmitting a control force onto the control piston.

The inventive valve arrangement is particularly suitable for pneumatically switching the supply of blowing air in a blow-moulding process. For example, it would be conceivable to use the inventive valve arrangement as part of a control block for controlling the blowing pressure of a stretch blow-moulding machine. However, the inventive valve arrangement can naturally also be used for other applications.

A valve arrangement of the initially cited type is used, in particular, in the manufacture of blow-moulded containers in order to realize a delivery of one or more blowing pressures that is coordinated with the realization of the blow-moulding process.

In the manufacture of plastic containers such as, in particular, PET bottles, a blank or parison of a thermoplastic material, for example PET (polyethylene terephthalate), is fed to different processing stations within a blow moulding machine.

A blow-moulding machine of this type usually has multiple blow-moulding stations that are arranged on a common blowing wheel and respectively feature a blowing device and a mould, in which the previously tempered parison is expanded into a container by means of biaxial orientation. In this case, a heating station for pre-heating the parisons is usually not provided on the blowing wheel itself, but rather in a continuous furnace arranged upstream thereof.

The expansion of the parisons is usually realized with the aid of compressed air (blowing air) that is introduced into the parison to be expanded while a stretching rod is simultaneously extended in order to guide the parison.

Various designs of the blowing stations used in such blow-moulding machines have been disclosed. In blowing stations that are arranged on rotating transport wheels, the mould carrier can frequently be opened similar to a book. However, mould carriers that are displaceable or guided relative to one another in a different way can also be used. Mould carriers in the form of plates arranged parallel to one another are typically used in stationary blowing stations that are particularly suitable for accommodating multiple cavities for moulding containers.

The tempered parison is usually blow-moulded into its final shape in several steps. To this end, the parison essentially features the finished top section of the bottle or container that is held in the blowing mould of the blow-moulding machine and connected to a compressed air system. The parison is blown up and ultimately provided with its final shape by blowing in compressed air (blowing air) through the top section of the bottle or container.

The actual blow-moulding process is therefore carried out in multiple stages, particularly in two stages, wherein a pre-blowing stage is initially carried out with a pressure value between 2 and 20 bar by means of a pre-blowing valve and a finish-blowing stage, in which the plastic container is moulded into its final shape, is subsequently carried out with a pressure value between 15 and 40 bar by means of a main blowing valve. These two valves are respectively connected to a compressed air supply with the corresponding level of pressurization.

The time factor plays an essential role, in particular, in the manufacture of blow-moulded containers. Especially for these applications, it is particularly imperative that the pneumatic valves for switching the supply of blowing air can be quickly opened, as well as quickly closed again.

The present invention therefore is based on the objective of enhancing a valve arrangement of the initially cited type in such a way that short switching times, particularly desirable switching times for the supply of blowing air in blow-moulding machines, can be realized with the least effort possible.

This objective is attained with the subject matter of independent claim 1. Advantageous enhancements of the inventive valve arrangement are disclosed in the dependent claims.

Accordingly, the invention proposes a valve arrangement featuring a main valve with a switching piston that is guided in a valve housing and can be displaced relative to the valve housing between a first position and a second position. The main valve is closed in the first position of the switching piston whereas the main valve is open in the second position.

The switching piston features a control surface that faces a control chamber of the valve housing and is designed for transmitting a control force onto the switching piston.

According to the invention, it is proposed that the valve arrangement features a control air switching chamber that is fluidically connected to the control chamber of the main valve via at least one bore. The control air for the main valve can be introduced into the control chamber of the main valve via the at least one bore that fluidically connects the control air switching chamber to the control chamber in order to close the main valve, i.e. to transfer the main valve into its first position. Furthermore, the control chamber can be vented via the at least one bore that fluidically connects the control air switching chamber to the control chamber when the main valve is opened.

A control air bore leads into the control air switching chamber and makes it possible to supply control air to the control air switching chamber. Furthermore, a venting bore leads into the control air switching chamber and makes it possible to vent the control chamber when the main valve is opened.

A closing element is accommodated in the control air switching chamber in a longitudinally displaceable fashion in such a way that the closing element can be displaced relative to the control air switching chamber between a first position, in which the control air bore leading into the control air switching chamber is closed by the closing element, and a second position, in which the venting bore leading into the control air switching chamber is closed by the closing element.

According to an aspect of the present invention, at least one first and at least one second bore are provided and respectively connect the control air switching chamber fluidically to the control chamber, wherein the at least one first and the at least one second bore are arranged in such a way that, in the first position of the closing element, the at least one first bore is closed by the closing element and the at least one second bore is exposed such that the venting bore is fluidically connected to the control chamber via the at least one second bore. In the second position of the closing element, in contrast, the at least one first bore is exposed such that the control air bore is fluidically connected to the control chamber via the at least one first bore. A non-return fitting, particularly a check valve, is arranged in the at least one first bore. This component only allows a gas flow from the control air switching chamber to the control chamber (but not in the opposite direction).

According to a preferred embodiment of the present invention, a pilot valve is furthermore provided in order to switch the supply of control air to the control chamber of the main valve, wherein the pilot valve is fluidically connected to the control air bore, and wherein the nominal width of the at least one first bore is at least as large as the nominal width of the pilot valve.

If the pilot valve has a nominal width between 0.4 and 2.0 mm, preferably between 0.8 and 1.6 mm, it is in this context particularly preferred that the at least one second bore has a nominal width of at least 2.0 mm, particularly at least 2.5 mm.

According to another aspect of the present invention, the at least one bore is arranged in such a way that it is neither covered and closed by the closing element in the first position nor in the second position of the closing element. In fact, the closing element is in this embodiment of the solution according to the present invention arranged between the control air bore and the at least one bore in its first position, as well as in its second position. In this embodiment, the closing element should be designed such that control air introduced into the control air switching chamber via the control air bore can pass through the closing element in the second position of the closing element.

Various designs may be considered for realizing the passage of control air through the closing element. For example, it would be conceivable that the closing element features a cap membrane. It would alternatively or additionally be conceivable to provide the closing element with through-holes or through-bores that extend in the longitudinal direction of the closing element and are arranged, in particular, in the peripheral circumferential area of the closing element. However, other designs may naturally also be considered.

In order to further reduce the switching times of the valve arrangements, it is advantageous if the control air switching chamber is arranged as close as possible to the control chamber of the main valve in order to shorten the length of connections between the control air switching chamber and the control chamber. To this end, it is advantageous if the control air switching chamber is realized in the valve housing.

The switching times can be additionally improved if the switching piston is realized low weight as possible, for example made of plastic, particularly PETP.

Exemplary embodiments of the present invention are described below with reference to the attached drawings.

In these drawings:

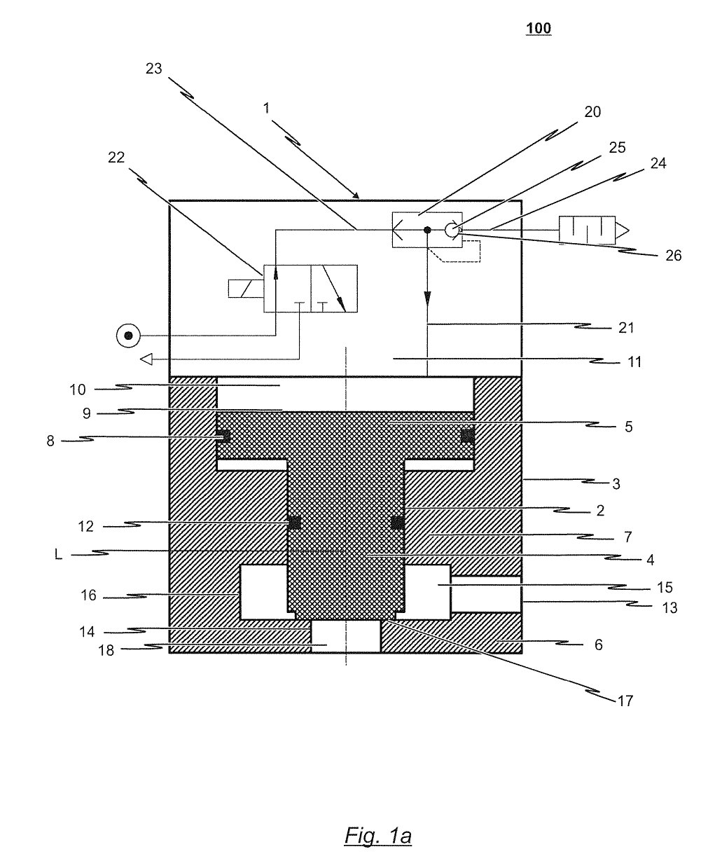

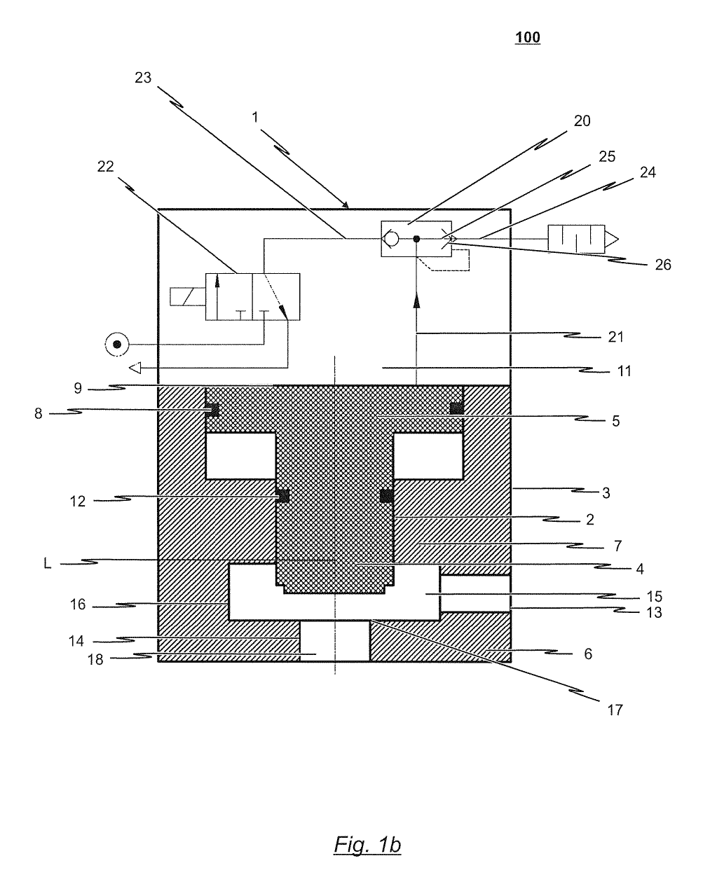

FIG. 1a shows a schematic vertical section through a valve arrangement according to a first exemplary embodiment, in which the main valve of the valve arrangement is in its closed state;

FIG. 1b shows a schematic vertical section through the valve arrangement according to FIG. 1a, in which the main valve of the valve arrangement is in its open state;

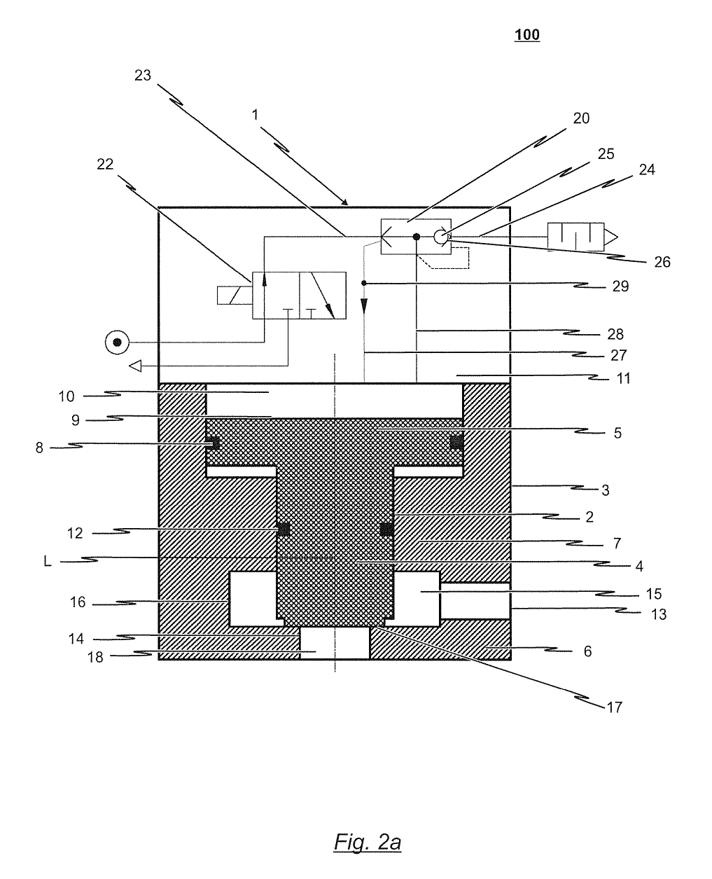

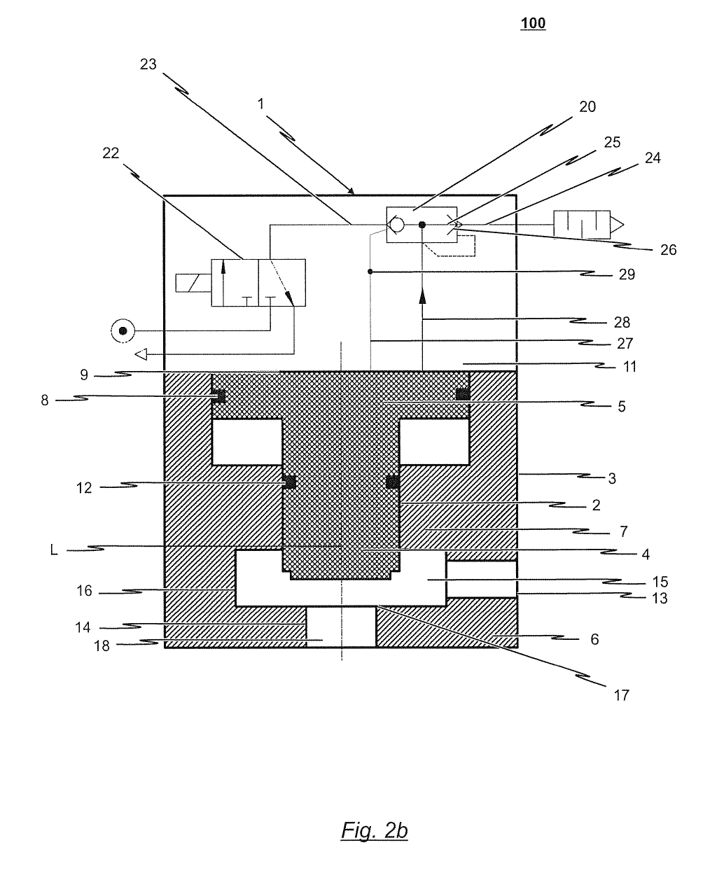

FIG. 2a shows a schematic vertical section through a valve arrangement according to a second exemplary embodiment, in which the main valve of the valve arrangement is in its closed state; and

FIG. 2b shows a schematic vertical section through the valve arrangement according to FIG. 2a, in which the main valve of the valve arrangement is in its open state.

Plastic containers, particularly plastic bottles such as, for example, PET bottles, can be manufactured by means of a stretch blow-moulding process. In this case, a heated (tempered) parison is mechanically stretched in the longitudinal direction and blow-moulded into the finished product (container) in multiple stages. Each of these blow-moulding stages corresponds to a certain blowing pressure. The corresponding blowing pressure required for the respective stage is delivered to the container to be moulded by opening a corresponding blowing pressure valve.

Due to the short blow-moulding times, it is imperative that the switching signals, particularly the electrical switching signals, for the blowing air valves are quickly and precisely implemented in the mechanical portion of the blow valves. Pilot-operated valve designs, which are composed of a pilot valve and a main valve, are frequently used for this purpose. In this case, the nominal width of the pilot valve is decisive for the switching time of the entire valve arrangement. The typical nominal width of conventionally used pilot valves amounts to approximately 1.0 mm. This nominal width is not sufficient for achieving the desired fast switch-over times required, in particular, in a stretch blow-moulding process.

In order to also allow the use of commercially available pilot valves with a nominal width of approximately 1.0 mm on blow valves, it would be conceivable to provide the relatively inexpensive pilot valves with a so-called booster stage in order to achieve the desired nominal widths of approximately 2.5 mm for the actuation of the main valve, as well as the correspondingly short switching times.

The present invention, which is described in greater detail below with reference to the exemplary embodiments illustrated in the drawings, also makes it possible to realize the fast switching times required for use in a blow-moulding machine with a pilot-operated valve that is not provided with a relatively complicated booster stage and utilizes an inexpensive pilot valve with a nominal width, for example, of approximately 1.0 mm.

In this context, the invention is based on the notion that, in terms of shortening the switching times of blow valves, it is particularly important to provide relatively large nominal widths for switching on the blowing pressure, i.e. for transferring the main valve into its open state, whereas the relatively small nominal widths of conventionally used and inexpensive pilot valves without booster stage on the order of approximately 1.0 mm already suffice for switching off the blowing pressure, i.e. for transferring the main valve into its closed state.

Different approaches may be considered in order to realize this notion.

A first approach is described in greater detail below with reference to the illustrations in FIGS. 1a and 1b. In this case, FIG. 1a shows a schematic vertical section through a first exemplary embodiment of the inventive valve arrangement 100, in which the main valve 1 is in its closed state. FIG. 1b likewise shows a schematic vertical section through the valve arrangement 100 according to the first exemplary embodiment, in which the main valve 1 is illustrated in its open state.

The valve arrangement 100 essentially consists of a main valve 1 and a pilot valve 22. The pilot valve serves for switching the control pressure required for the actuation of the main valve 1.

The main valve 1 features a switching piston 2 that is accommodated in a valve housing 3. The switching piston 2 is essentially composed of a piston shaft 4 and a piston head 5. In the exemplary embodiments illustrated in the drawings, the piston shaft 4 and the piston head essentially extend symmetrically along a longitudinal piston axis L and jointly form a T-shaped basic structure of the switching piston 2 in the vertical section shown.

The piston shaft 4 extends through a piston sleeve 7 that is connected to a valve base 6 and sealed relative to the piston sleeve 7 with a seal 8. The seal 8 may be realized, for example, in the form of an O-ring.

The piston head 5 features a control surface 9 that can be acted upon with a control pressure in order to position the switching piston 2 within the valve housing 3. A control chamber 10 is formed adjacent to the control surface 9 of the switching piston 2 and sectionally defined by a valve housing top section 11. The valve housing top section 11 forms part of the valve housing 3 and is connected to the valve base 6. The piston head is sealed relative to an inner wall of the valve housing top section 11 by means of a seal 12. A (not-shown) damping element may be inserted into the piston head 5 in order to ensure a fixed stop absorption during the positioning of the switching piston 2.

A blowing air inlet channel 14 and a blowing air outlet channel 13 are formed in the valve base 6, wherein these two channels are in a valve housing interior 15 defined by the inner wall 16 of the valve base 6. In a section facing the valve housing interior 15, the blowing air supply channel 14 provides a main flow path for the blowing pressure to be switched.

FIG. 1a shows the main valve 1 of the valve arrangement 100 according to an exemplary embodiment in its closed state, i.e. in a state in which the main flow path is closed. In this case, the switching piston 2 is respectively pressed against a valve seat 17 and the edge of the main flow path and thereby seals the valve housing interior 15 relative to the main flow path.

A control pressure can be applied to the control chamber 10 realized in the upper section of the valve housing 3, wherein said control pressure then acts upon the control surface 9 of the piston head 5 and subjects the switching piston 2 to a force that is greater than the force exerted upon the respective surface of the switching piston 2 and the piston shaft 4, which is subjected to the blowing pressure, by the main pressure (blowing pressure). This causes the main valve 1 to close.

When the control pressure is lowered, the switching piston is displaced in the direction of the longitudinal piston axis L due to the high pressure acting thereupon such that the switching piston 2 is no longer pressed against the valve seat 17 and the high pressure (blowing pressure) can be transferred from the main flow path 18 into the region of the blowing air discharge channel 13 through the valve housing interior 15. The main valve is therefore in its open state.

When the control pressure is once again increased, the switching piston 2 returns into its first position, in which the main valve 1 is closed and in which the switching piston 2 is pressed against the valve seat 1.

In order to transfer the main valve 1 into its open state (see FIG. 1b), it is necessary to provide suitable venting of the control chamber 10. For this purpose, at least one bore (just one bore 21 in the exemplary embodiment illustrated in FIGS. 1a and 1b) leads into the control chamber 10 and makes it possible to deliver the control pressure required for closing the main valve 1 into the control chamber 10, as well as to correspondingly vent the control chamber 10 in order to open the main valve 1.

In the exemplary embodiment of the valve arrangement 100 according to the invention illustrated in FIGS 1a and 1b, the bore 21 serves for fluidically connecting the control chamber 10 of the main valve 1 to a control air switching chamber 20. The control air switching chamber 20 is preferably arranged in the immediate vicinity of the control chamber 10 in order to keep the fluidic connection between the control air switching chamber 20 and the control chamber 10 as short as possible such that the dead volume is reduced and the attainable switching times of the main valve 1 are optimized. To this end, the control air switching chamber 20 is preferably realized within the valve housing top section 11.

A control air bore 23, which is likewise realized in the valve housing top section 11, and a venting bore 24 lead into the control air switching chamber 20. As shown, the control air bore 23 and the venting bore 24 lead into the control air switching chamber 20 on two opposite lateral surfaces of the control air switching chamber 20.

The control air bore 23 is fluidically connected to a pilot valve 22 of the valve arrangement 100. The control pressure required for actuating the switching piston 2 is switched by means of this pilot valve.

The venting bore 24 leading into the control air switching chamber 23 can be fluidically connected to the control chamber 10 via the bore 21 in order to vent the control chamber 10 when the main valve 1 is opened.

A closing element 25 is arranged in the control air switching chamber and can be displaced relative to the control air switching chamber 20 along a longitudinal axis of the closing element 25. The closing element 25 specifically can be displaced between a first position and a second position. In the first position of the closing element 25, the control air bore 23 leading into the control air switching chamber 20 is closed by the closing element 25 (see FIG. 1b). In the second position of the closing element 25 illustrated in FIG. 1a, in contrast, the closing element 25 closes the venting bore 24 leading into the control air switching chamber 20 while the control air bore 23 is fluidically connected to the interior of the control air switching chamber 20.

In the exemplary embodiment of the inventive valve arrangement 100 which is schematically illustrated in FIGS. 1a and 1b, it is essential to arrange the bore 21 in such a way that it is neither covered and closed by the closing element 25 in the first position nor in the second position of the closing element 25. For this purpose, the venting bore 24 leads into the control air switching chamber 20 in the form of a closing element seat 26 that protrudes into the control air switching chamber 20.

In the exemplary embodiment illustrated in FIGS. 1a and 1b, it is furthermore essential that the closing element 25 is arranged between the control air bore 23 and the bore 21 in its first position and in its second position, as well as designed such that control air introduced into the control air switching chamber 20 via the control air bore 23 can pass through the closing element 25 in the second position of the closing element 25 (see FIG. 1a).

In this context, it would be conceivable, in particular, that the closing element 25 features a cap membrane in order to allow control air introduced into the control air switching chamber 20 via the control air bore 23 to flow between the inner wall of the control air switching chamber 20 and the closing element 25. The control air therefore reaches the control chamber 10 of the main valve 1 via the bore 21 as indicated with arrows in FIG. 1a.

The bore 21 has a nominal width (diameter) of at least 2.5 mm in order to realize the broad nominal width required for switching on the blowing pressure, i.e. when the main valve 1 is opened. Consequently, a combination of a broad nominal width for switching on the blowing pressure and a small nominal width for switching off the blowing pressure can be technically implemented in a simple yet effective fashion without a complicated booster circuit.

FIG. 1a specifically shows a state, in which the pilot valve is switched on and the closing element 25 is pressed against the closing element seat 26. In FIG. 1b, in contrast, the pilot valve is switched off and the closing element 25 is pressed against the control air bore 23 due to the pressure in the control chamber 10. The control chamber 10 can then be quickly vented via the relatively large bore 21 as indicated with arrows in FIG. 1b.

Another exemplary embodiment of the inventive valve arrangement 100 is illustrated in FIGS. 2a and 2b, wherein FIG. 2a shows a schematic vertical section through the valve arrangement 100, in which the main valve 1 is in its closed state. In FIG. 2b, in contrast, the main valve 1 is illustrated in its open state.

The additional embodiment of the inventive solution illustrated in FIGS. 2a and 2b can be distinguished from the above-described embodiment as follows:

In the embodiment illustrated in FIGS. 2a and 2b, a first bore 27 and a second bore 28 are used instead of the (single) bore 21 that fluidically connects the control air switching chamber 20 to the control chamber 10. Both bores 27, 28 fluidically connect the control air switching chamber 20 to the control chamber 10. In this case, the first bore 27 serves for supplying the control air made available by the control air bore 23 into the control chamber 10 (see FIG. 2a). The second bore 28, in contrast, serves as a quick-venting bore as indicated in the illustration according to FIG. 2b.

As soon as control air is supplied via the pilot valve, the closing element 25 is pressed, in particular, against the closing element seat 26 and the venting bore 24 consequently is closed by the closing element 25. Due to the displacement of the closing element 25 relative to the control air switching chamber 20 and, in particular, relative to the first bore 27, the first bore 27 is not covered by the closing element 25 in the second position of the closing element 25 (see FIG. 2a) such that the control air can directly flow into the control chamber 10.

When the pilot valve is switched off, the pressure in the control air bore 23 drops due to the check valve 29 arranged in the first bore 27 such that the closing element 25 is transferred into its state illustrated in FIG. 2b and quick-venting can be realized via the second bore 28.

The invention is not limited to the exemplary embodiment of the inventive valve arrangement 100 illustrated in the drawings, but rather results from a synopsis of all characteristics disclosed herein.

1. A valve arrangement, particularly for pneumatically switching the supply of blowing air in a blow-moulding process, wherein the valve arrangement features a main valve with a switching piston that is guided in a valve housing and can be displaced relative to the valve housing between a first position, in which the main valve is closed, and a second position, in which the main valve is open, and wherein the switching piston features solely a control surface for control air that faces a control chamber of the valve housing and is configured to transmit a control force exerted by the control air acting in a direction or the first position onto the switching piston,
characterized by
wherein at least one bore that fluidically connects a control air switching chamber to the control chamber and makes it possible to introduce control air from the control air switching chamber into the control chamber in order to close the main valve, as well as to vent the control chamber via the control air switching chamber when the main valve is opened, wherein control air can be supplied to the control air switching chamber via a control air bore leading into the control air switching chamber, and wherein a venting bore leading into the control air switching chamber is provided and makes it possible to vent the control chamber when the main valve is opened.

2. The valve arrangement according to claim 1, wherein a closing element is provided and guided in the control air switching chamber such that it can be displaced relative to the control air switching chamber between a first position, in which the control air bore leading into the control air switching chamber is closed by the closing element, and a second position, in which the venting bore leading into the control air switching chamber is closed by the closing element.

3. The valve arrangement according to claim 2, wherein at least one first bore for fluidically connecting the control air switching chamber to the control chamber and at least one second bore for fluidically connecting the control air switching chamber to the control chamber are provided, wherein the at least one first and the at least one second bore are arranged in such a way that, in the first position of the closing element, the at least one first bore is closed by the closing element and the at least one second bore is exposed such that the venting bore is fluidically connected to the control chamber via the at least one second bore, and wherein the at least one first bore is in the second position of the closing element exposed such that the control air bore is fluidically connected to the control chamber via the at least one first bore.

4. The valve arrangement according to claim 3, wherein a pilot valve is furthermore provided in order to switch the supply of control air to the control chamber of the main valve, wherein the pilot valve is fluidically connected to the control air bore, and wherein the nominal width of the at least one first bore is at least as large as the nominal width of the pilot valve.

5. The valve arrangement according to claim 4, wherein the nominal width of the pilot valve lies between 0.4 and 2.0 mm, and wherein the nominal width of the at least one second bore amounts to at least 2.0 mm.

6. The valve arrangement according to claim 3, wherein a non-return fitting, which only allows a gas flow from the control air switching chamber to the control chamber, is arranged in the at least one bore.

7. The valve arrangement according to claim 2, wherein the at least one bore is arranged in such a way that it is neither covered and closed by the closing element in the first position nor in the second position of the closing element, and wherein the closing element is arranged between the control air bore and the at least one bore in its first position, as well as in its second position, and designed in such a way that the control air introduced into the control air switching chamber through the control air bore can pass through the closing element in the second position of the closing element.

8. The valve arrangement according to claim 7, wherein the closing element features a cap membrane.

9. The valve arrangement according to claim 7, wherein the closing element features through-bores that extend in the longitudinal direction of the closing element and are arranged in the peripheral circumferential area of the closing element.

10. The valve arrangement according to claim 1, wherein the switching piston features a piston shaft, and wherein the control surface of the switching piston is dimensioned larger than the cross-sectional area of the piston shaft.

11. The valve arrangement according to claim 1, wherein the switching piston is at least sectionally made of plastic.

12. The valve arrangement according to claim 1, wherein the control air switching chamber is realized in the valve housing.

13. The valve arrangement according to claim 5, wherein the nominal width of the pilot valve lies between 0.8 and 1.6 mm, and wherein the nominal width of the at least one second bore amounts to at least 2.5 mm

14. The valve arrangement according to claim 11, wherein the switching piston is at least sectionally made of PETP.
